(19) United States
(12) Patent Application Publication
(10) Pub. No.: US 2006/0246959 A1
(43) Pub. Date: Nov. 2, 2006

(54) Method and apparatus for presence based cell phone ringing

(75) Inventors: Dave Winikoff, Menlo Park, CA (US); Rami Caspi, Sunnyvale, CA (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Communications, Inc.

(21) Appl. No.: 11/118,032

(22) Filed: Apr. 29, 2005

(51) Int. Cl. H04Q 7/20; H04M 1/00; H04B 1/38

(52) U.S. Cl. 455/567; 455/466

(57) ABSTRACT

A telecommunications system includes a presence service; a wireless telephone service; and a plurality of user devices having notification controls configured to provide a notification indicia to a user indicative of an incoming call using said wireless telephone service; wherein said notification controls are configured to change a notification indicia based on an input from said presence service.

### BACKGROUND OF THE INVENTION

1. Field of the Invention

The present invention relate to telecommunications systems and, in particular, to an improved telephone ringing system.

2. Description of the Related Art

In the modern telecommunications environment, users are increasingly dependent upon cellular telephones. In many cases, the cellular telephone is the user's only available telecommunications device. For example, a user may need to rely exclusively on the cellular telephone when wired connectivity or other forms of wireless connectivity (e.g., WiFi) are not available.

In many social and business environments, however, it may be inappropriate for the user to receive telephone calls. In cases such as theatre, meetings, etc., users are frequently asked to turn off their cell phone ringers. Failure to do so can result in an embarrassing situation and/or social ostracism.

While a user can turn off the ringer or, with certain cell phones, change to a “vibrate” mode, manually changing the ringer setting can be awkward or inconvenient. Further, the user may not remember to reset the ringer when the occasion requiring it to be off has ended, and thereby miss an important call.

### SUMMARY OF THE INVENTION

These and other drawbacks in the prior art are overcome in large part by a system and method according to embodiments of the present invention.

A telecommunications device according to embodiments of the present invention includes a telephony controller; a presence controller configured to provide an indication of an identity context associated with a user of the telecommunications device; and a ringer controller configured to control an output of a ringer, said ringer adapted to provide an output when an incoming call is detected by said telephony controller; wherein said ringer controller is configured to select a particular output responsive to said indication.

A method according to embodiments of the present invention includes receiving a user presence indication at a cellular telephone; accessing a ring configuration of said cellular telephone responsive to said receiving; and changing said ring configuration based on said user presence indication.

A telecommunications system according to embodiments of the present invention includes a presence service; a wireless telephone service; and a plurality of user devices having notification controls configured to provide a notification indicia to a user indicative of an incoming call using said wireless telephone service; wherein said notification controls are configured to change a notification indicia based on an input from said presence service.

### BRIEF DESCRIPTION OF THE DRAWINGS

The present invention may be better understood, and its numerous objects, features, and advantages made apparent to those skilled in the art by referencing the accompanying drawings. The use of the same reference symbols in different drawings indicates similar or identical items.

FIG. 1 is a diagram schematically illustrating a system according to embodiments of the present invention.

FIG. 2 is a diagram schematically illustrating a system according to embodiments of the present invention.

FIG. 3 illustrates a telecommunications system according to an embodiment of the present invention.

FIG. 4 is a block diagram of an exemplary cellular telephone in accordance with embodiments of the present invention.

FIG. 5 is a flowchart illustrating operation of an embodiment of the present invention.

FIG. 6 is a flowchart illustrating operation of an embodiment of the present invention.

FIG. 7 is a flowchart illustrating operation of an embodiment of the present invention.

FIG. 8 is a block diagram of a user device according to an embodiment of the present invention.

FIG. 9 is a block diagram of a server according to an embodiment of the present invention.

### DETAILED DESCRIPTION OF EMBODIMENTS OF THE INVENTION

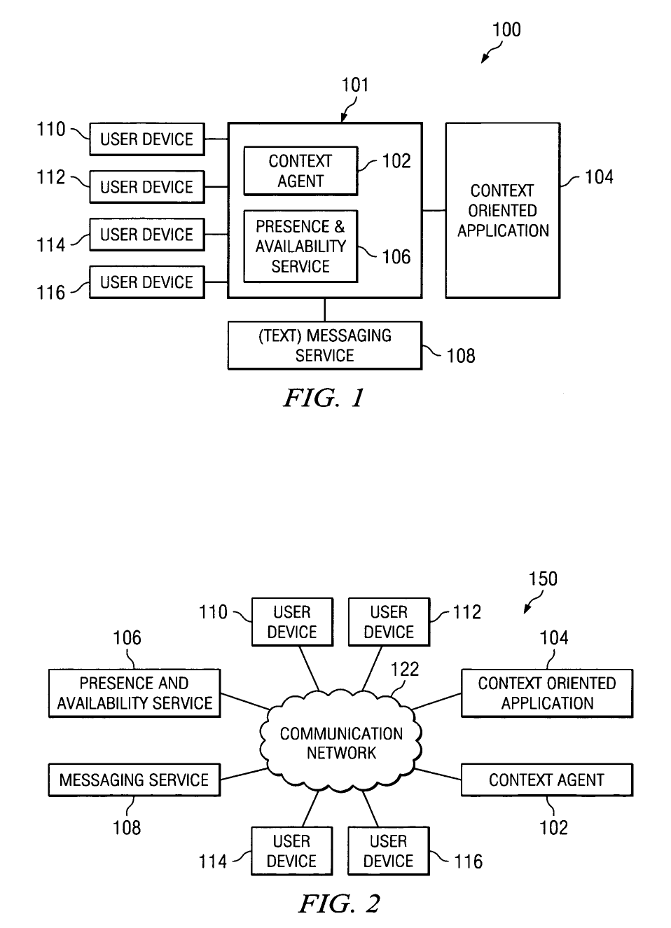

Turning now to the drawings and, with particular attention to FIG. 1, a diagram of a telecommunications system 100 according to an embodiment of the present invention is shown. The system includes a presence service 101 connected to or in communication with a context oriented application 104. The presence service 101 may include a presence and availability service (PAS) 106 and a context agent 102. The presence service 101 may also be connected to or in communication with a messaging service, such as a text-messaging service 108.

User devices, such as user devices 110, 112, 114, 116 may be coupled to or in communication with the presence service 101 and the text messaging service 108. In certain embodiments, the user devices 110, 112, 114, 116 may be implemented as portable electronic devices, such as cellular telephones. User devices implemented as cellular telephones may be equipped with presence controls, i.e., a software and/or firmware application for processing presence information, for receiving presence information, as well as user notification or ringer controls, as will be explained in greater detail below. In accordance with embodiments of the present invention, the presence controls and ringer controls may be used to set particular ringer states based on the user's presence state.

In certain embodiments, the system 100 may also include other hardware and/or software components (e.g., gateways, proxy servers, registration server, presence servers, redirect servers, databases, applications, etc.) such as, for example, hardware and software used to support a SIP (Session Initiation Protocol) or other protocol based infrastructure for the system 100 and allow the registration of SIP devices in the system 100.

The context agent 102 may monitor the identity context of one or more identities or the device contexts of one or more devices. The context agent 102 may provide or include an application interface that supports identity context, device context, device presence, and/or other functions. Applications may monitor, access, and/or query the context agent 102 for presence states, i.e., user availability, and/or device context information. The context agent 102 may be implemented in hardware and/or software operating on one or more servers, computer systems, host or mainframe computers, workstations, etc. In some embodiments, the context agent 102 may be operating on some or all of the same devices as other components in the system 100.

The PAS 106 may be or include an application that monitors the presence and availability of devices. That is, the PAS 106 monitors the context of one or more users or devices. In some embodiments, one or more of the devices may be associated with identities whose context may be used or monitored by the context oriented application 104. The PAS 106 may be implemented in hardware and/or software operating on one or more servers, computer systems, host or mainframe computers, workstations, etc. In some embodiments, the PAS 106 may be operating on some or all of the same devices as other components in the system 100.

In some embodiments, the PAS 106 may be or include an application that communicates with or is connected to one or more registered devices (e.g., devices 110, 112, 114, 116) that allows devices to register with the system 100 or helps to facilitate their registration. For example, in a SIP environment, the devices 110, 112, 114, 116 may be registered with the system 100 and may show up or be described in registration databases as being assigned to particular identities. The context agent 102 may register with the PAS 106 and receive device context and/or information from the PAS 106 regarding the devices 110, 112, 114, 116. In some embodiments, the PAS 106 may provide context information to the context oriented application 104 upon request, periodically or in accordance with some other plan or procedure.

In some embodiments, exemplary contexts could be a state of “in meeting,” “on vacation,” “in the office,” “out of the office,” “roaming,” “offline,” “online,” “unknown,” “on business trip,” “in transit,” “mobile,” “busy,” etc. Thus, the context describes the implied availability of the user. In some embodiments, different applications may be used to set, monitor or change an identity context for an identity. For example, a calendar program, telephone user interface, graphical user interface, plug-in, etc. may allow or enable an identity to set or change a presence context for the user manually or automatically.

As will be explained in greater detail below, embodiments of the present invention allow the user to coordinate or associate a particular ring for his cellular telephone with a presence state. The following table provides exemplary ring tones associated with exemplary presence states.

| Presence State | Ring Tone | Description |
|---|---|---|
| In Office | Melody #1 | Short, low intensity melody, |
| | | not to disturb other co- |
| | | workers in cubicle |
| | | environment |
| Out to Lunch | Melody #2 | High intensity ring-tone, |
| | | intended for loud |
| | | environment, such as in a |
| | | crowded cafeteria, during |
| | | lunch time |
| In a Meeting | Vibration Mode | Prevents cell phone from |
| | | ringing out loud |
| Busy | Melody #3 | A single beep |

In certain embodiments of the present invention, one or more of the components of the system 100 may be connected to or in communication with each other via a communication network. For example, turning now to FIG. 2, a system 150 including the components of the system 100 is illustrated, wherein some or all of the components are in communication via a network 122. The network 122 may be or include the Internet, World Wide Web, a local area network, or some other public or private computer, cable, telephone, client/server, peer-to-peer, or communication network or intranet. In some embodiments, the communication network can also include other public and/or private wide area networks, local area networks, wireless networks, data communications networks, or connections, intranets, routers, satellite links, microwave links, cellular or telephone networks, radio links, fiber optic transmission lines, ISDN lines, T1 lines, DSL connections, etc. Moreover, as used herein, communications include those enabled by wired or wireless technology. In some embodiments, some or all of the network 122 may be implemented using a TCP/IP network and may implement voice or multimedia over IP using, for example, the Session Initiation Protocol (SIP).

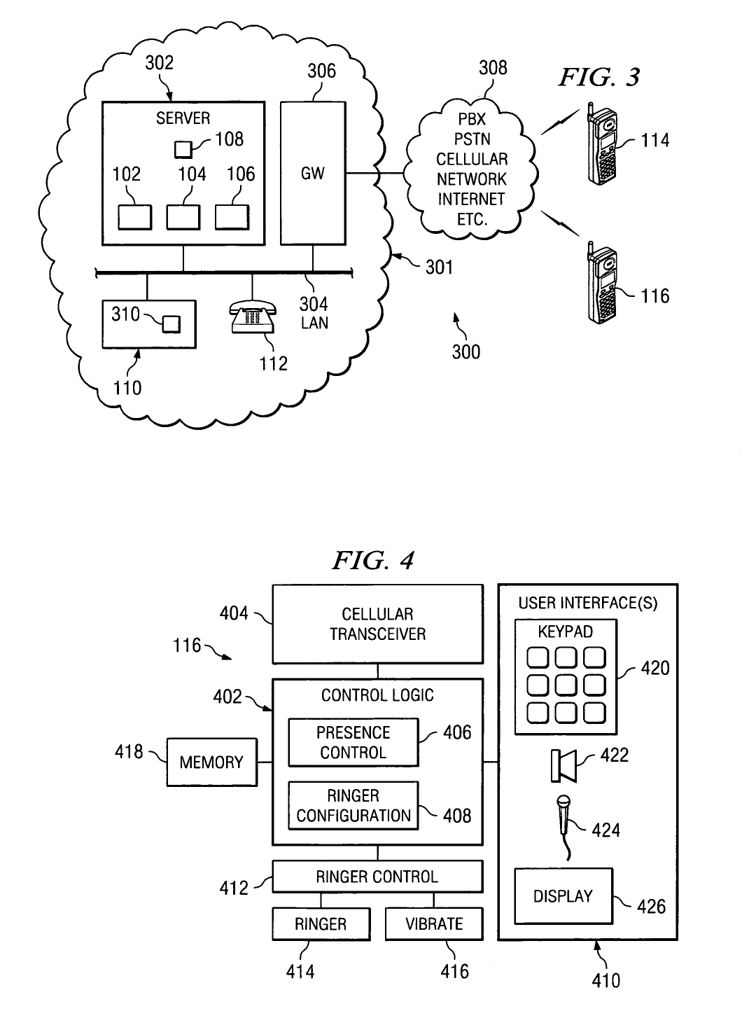

An exemplary network architecture that may be suitable for use with embodiments of the present invention is shown in FIG. 3. As shown, the system 300 includes an enterprise network 301 and a public network 308. The enterprise network 301 may include a wired or wireless local area network (LAN) 304. A server 302 may be embodied as a presence server implementing a context agent 102, context oriented application 104, presence and availability service 106, and messaging service 108 may be coupled to the LAN 304. An exemplary presence service is part of the Siemens Openscape presence aggregation middleware, available from Siemens Corporation.

Also coupled, connected to or in communication with the LAN 304 may be one or more user devices 110, 112. The user devices 110, 112 may be implemented as personal computers 110 or digital telephones 112, such as Internet Protocol (IP) based digital telephones.

An exemplary personal computer 110 may also include a presence portal 310, which can be used to set the user's presence state and/or receive the presence states of other users across one or more user devices.

A gateway 306 may also be coupled to the LAN 304. The gateway 306 provides an interface to the public network 308, which may be implemented, for example, as one or more of the PSTN, cellular telephone network, Internet, one or more PBX's, and the like. One or more user devices 114, 116, which may be implemented as one or more cellular telephones, may be in communication with the public network 308.

In certain embodiments, the user may be associated with one or more user devices. For example, the user may be associated with a personal computer 110 including a presence portal 310, and a cellular telephone 114.

In operation, a user can configure his cellular telephone to associate a particular ring with a particular presence state. When the cell phone receives the presence context information, the ring tone may be reset in accordance with the user configuration. When an incoming call is received, the ring tone is provided in accordance with that configuration.

As noted above, the presence information may be set by the user or automatically by the system. The presence information may be set by the user using his presence portal 310 at his personal computer 110. The presence information is then received by the presence and availability service 102 and context agent 104 and provided to other user devices, such as a cellular telephone equipped with a presence agent. An exemplary cellular telephone equipped with a presence agent is the Siemens SX-1 cellular telephone, available from Siemens Corporation.

An exemplary cellular telephone 116 including ringer configuration capabilities in accordance with an embodiment of the present invention is shown in FIG. 4. In some embodiments, the cellular telephone 116 may implement one or more elements of the methods disclosed herein. As shown, the cellular telephone includes control logic 402 and cellular transceiver 404. The cellular transceiver 404 allows communication over a cellular telephone network, such as a GSM or GPRS based cellular telephone network. The control logic 402 generally controls operation of the cellular telephone and includes a presence control 406 and a one or more context-oriented applications, such as ringer configuration unit 408 in accordance with embodiments of the present invention.

The control logic interfaces to a memory 418 for storing, among other things, program controls and audio ringer files; a ringer control 412 for controlling operation of a ringer 414 and a vibration mode ringer 416; and user interface(s) 410. The user interface(s) 410 can include a keypad 420, speaker 422, microphone 424, and display 426. The keypad may include one or more “hard” keys and may be implemented in whole or in part as a cursor pointing device in association with one or more “virtual” keys on the display 426. It is noted that other interfaces, such as voice activated interfaces may be provided. Thus, the figure is exemplary only.

As noted above, the control logic 402 may implement a presence control 406 and a ringer configuration control 408. The control logic may be implemented as various combinations of hardware, software, or firmware and, in particular, may be implemented as one or more control processors. The presence control 406 may be a presence agent similar to the presence agent 310 of personal computer 110 (FIG. 3) and allow the user to set presence states at the cellular telephone itself, as well as receive presence portal information, messages, or indicia directly from the presence server 302. Alternatively, the presence control 406 may be implemented as hardware, software, or firmware that can receive messages in other formats, such as a presence text message, from the presence server 302, such as via the text messaging service 108 indicative of a presence state of the user. The text message may be in a format compatible with the short messaging service (SMS), for example. An exemplary system for providing such presence information is described in co-pending U.S. patent application Ser. No. 10/383,777, titled Short Message Service Control of an Integrated Communications Center, filed Mar. 7, 2003, which is hereby incorporated by reference in its entirety as if fully set forth herein. Other ways of conveying presence information between the presence server 302 and the presence control 406 may include SIP methods over TCP using GPRS or EDGE data services.

In general, user may access the ringer configuration unit 408 via one or more of the user interface(s) 410 to set the ringer tone and presence state association. Once configured, the ringer control 412 controls operation of the ringer 414 and vibration mode ringer 416 in accordance with the configuration. Then, when the presence control 406 receives and/or generates a presence state indicia from the context agent 104, it provides the state to the ringer control 412, which can then activate the ringer 414 or vibration mode ringer 416 with the appropriate ring tone.

The user may store ring tones or the presence state to ring tone configuration information in a table stored in memory 418. In certain embodiments, the information may be transmitted to the cell phone, e.g., downloaded using the GPRS or EDGE link of the cell phone, or manually when the cell phone firmware is updated.

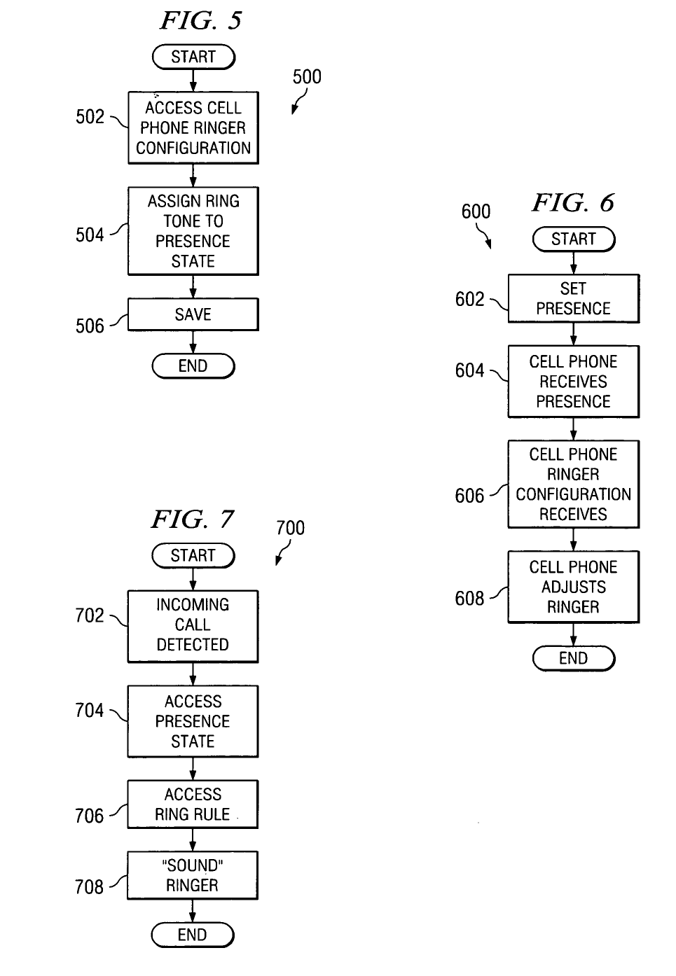

Turning now to FIG. 5, a flowchart 500 illustrating operation of an embodiment of the present invention is shown. The particular arrangement of elements in the flowchart 500 is not meant to imply a fixed order to the elements; embodiments can be practiced in any order that is practicable.

In a step 502, a user of a cellular telephone can use his user interface(s) 410 (FIG. 4) to access configuration control 408. In a step 504, the user can employ the configuration control 408 to set or assign one or more presence states or contexts with a corresponding ringer setting. For example, in certain embodiments, the user can set presence and ringer tone according to the above described table. Finally, in a step 506, the user can save the new settings. It is noted that, in alternate embodiments, the setting of the presence and ringer associations can be accomplished at the factory or in accordance with a company information technology (IT) policy. In other embodiments, user configuration can simply be changing or confirming pre-set default settings. In addition, it is noted that the particular melodies or tones may be chosen from a preconfigured list stored in memory or newly downloaded to the cellular telephone and stored in memory 418. Finally, in other embodiments, setting the associations can include downloading the settings to the cellular telephone.

FIG. 6 is a flowchart illustrating operation of another embodiment of the present invention. The particular arrangement of elements in the flowchart 600 is not meant to imply a fixed order to the elements; embodiments can be practiced in any order that is practicable.

In a step 602, the user presence is set. As noted above, this can include the user setting the state at a personal computer operably coupled to the server 302, directly at the cell phone, or automatically according to other criteria. In a step 604, the cell phone presence control 406 receives one or more indicia indicative of the presence state, e.g., automatically communicated from the presence service or directly set by the user. In a step 606, the cell phone ringer configuration unit 408 receives the presence indicia and changes the settings as appropriate, for example, according to the above table. In a step 608, the changed settings are saved to memory. Then, when an incoming call is received, the appropriate ringer is sounded or used.

It is noted that, while the change to ringer settings can be made each time the presence state changes, a check on the settings could also be done in response to an incoming call. That is, once a call is detected as incoming, the cell phone could access the presence state and then determine the ringer setting.

This is illustrated more particularly in FIG. 7, which is a flowchart illustrating operation of another embodiment of the present invention. The particular arrangement of elements in the flowchart 700 is not meant to imply a fixed order to the elements; embodiments can be practiced in any order that is practicable.

In a step 702, the cellular telephone detects an incoming telephone call. For example, the cellular telephone could receive call signaling according to a particular cellular telephone protocol, such as GSM, and the like. In a step 704, in response to detecting an incoming call, the presence controller 406 accesses the presence information. As noted above, the presence information may be provided via communication with the presence and availability service 104 or the context agent 102 using GPRS, EDGE or the like.

Once the presence state has been determined, the cell phone will access the ring configuration rule, in a step 706. Finally, in a step 708, the cell phone's ringer control 412 will cause the ringer 414 or vibration mode ringer to deliver the appropriate ring tone or vibration in accordance with the presence rule. As noted above, this can include the cell phone accessing memory for a suitable sound file or activation of a vibration device.

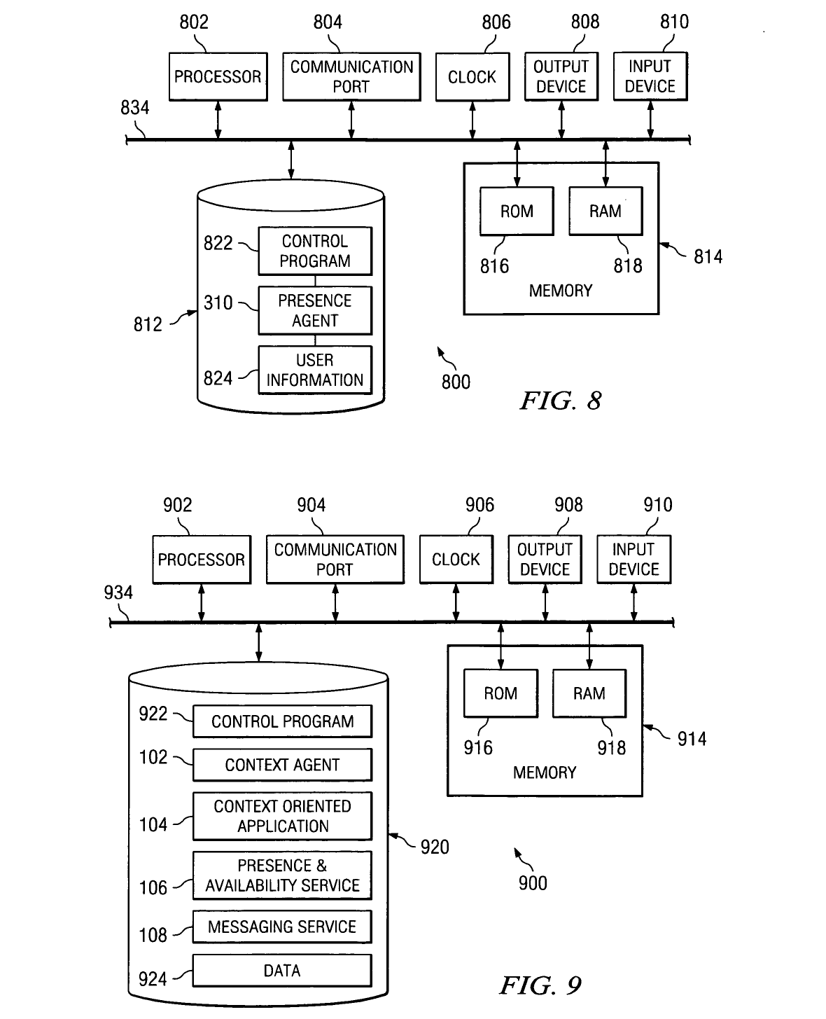

Now referring to FIG. 8, a representative block diagram of a computer or processing device 800 suitable for use as a user device according to embodiments of the present invention is shown. In particular, the computer 800 may be a device suitable for setting one or more presence states of the user and may be implement the personal computer 110 of FIG. 3. In some embodiments, the computer 800 may include or operate a presence agent or client 310. The computer 800 may be embodied as a single device or computer, a networked set or group of devices or computers, a workstation, mainframe or host computer, etc. In some embodiments, the computer 800 may implement one or more elements of the methods disclosed herein.

The computer 800 may include a processor, microchip, central processing unit, or computer 802 that is in communication with or otherwise uses or includes one or more communication ports or network interfaces 804 for communicating with user devices and/or other devices. The communication ports 804 may include such things as local area network adapters, wireless communication devices, Bluetooth technology, etc. The computer 800 also may include an internal clock element 806 to maintain an accurate time and date for the computer 800, create time stamps for communications received or sent by the computer 800, etc.

If desired, the computer 800 may include one or more output devices 808 such as a printer, infrared or other transmitter, antenna, audio speaker, display screen or monitor, text to speech converter, etc., as well as one or more input devices 810 such as a bar code reader or other optical scanner, infrared or other receiver, antenna, magnetic stripe reader, image scanner, roller ball, touch pad, joystick, touch screen, microphone, computer keyboard, computer mouse, etc.

In addition to the above, the computer 800 may include a memory or data storage device 812 to store information, software, databases, documents, communications, device drivers, etc. The memory or data storage device 812 may be implemented as an appropriate combination of magnetic, optical and/or semiconductor memory, and may include, for example, Read-Only Memory (ROM), Random Access Memory (RAM), a tape drive, flash memory, a floppy disk drive, a Zip™ disk drive, a compact disc and/or a hard disk. Thus, the storage device 812 may include various combinations of moveable and fixed storage. The computer 800 also may include memory 814, such as ROM 816 and RAM 818.

The processor 802 and the data storage device 812 in the computer 800 each may be, for example: (i) located entirely within a single computer or other computing device; or (ii) connected to each other by a remote communication medium, such as a serial port cable, telephone line or radio frequency transceiver. In one embodiment, the computer 800 may be implemented as one or more computers that are connected to a remote server computer, as will be explained in greater detail below.

A conventional personal computer or workstation with sufficient memory and processing capability may be used as the computer 800. The computer 800 may be capable of high volume transaction processing, performing a significant number of mathematical calculations in processing communications and database searches. A Pentium™ microprocessor such as the Pentium III™ or IV™ microprocessor, manufactured by Intel Corporation may be used for the processor 802. Other suitable processors may be available from Motorola, Inc., AMD, or Sun Microsystems, Inc. The processor 802 also may be embodied as one or more microprocessors, computers, computer systems, etc.

Software may be resident and operating or operational on the computer 800. The software may be stored on the data storage device 812 and may include a client control program 822 for operating the computer. The client control program 822 may include or interface to a presence client control program 310. The presence client control program 310 may allow the user device to interact with the presence service 106.

The client control program 822 may control the processor 802. The processor 802 may perform instructions of the client control program 820, and thereby operate in accordance with the methods described in detail herein. The client control program 822 may be stored in a compressed, uncompiled and/or encrypted format. The client control program 822 furthermore includes program elements that may be necessary, such as an operating system, a database management system and device drivers for allowing the processor 802 to interface with peripheral devices, databases, etc. Appropriate program elements are known to those skilled in the art, and need not be described in detail herein.

The computer 800 also may include or store user information 824, such as information regarding identities, user devices, contexts, presence information, communications, etc. This information may also include audio files downloadable to the cellular telephone for use as ringer tones. Information regarding other application program data may be stored in application databases (not shown)

According to some embodiments, the instructions of the control program may be read into a main memory from another computer-readable medium, such as from the ROM 816 to the RAM 818. Execution of sequences of the instructions in the control program causes the processor 802 to perform the process elements described herein. In alternative embodiments, hard-wired circuitry may be used in place of, or in combination with, software instructions for implementation of some or all of the methods described herein. Thus, embodiments are not limited to any specific combination of hardware and software.

The processor 802, communication ports 804, clock 806, output device 808, input device 810, data storage device 812, ROM 816 and RAM 818 may communicate or be connected directly or indirectly in a variety of ways. For example, the processor 802, communication ports 804, clock 806, output device 808, input device 810, data storage device 812, ROM 816 and RAM 818 may be connected via a bus 834.

While specific implementations and hardware/software configurations for the computer 800 have been illustrated, it should be noted that other implementations and hardware configurations are possible and that no specific implementation or hardware/software configuration is needed. Thus, not all of the components illustrated in FIG. 8 may be needed for the computer 800 implementing the methods disclosed herein.

FIG. 9 is a diagram illustrating a server 900 according to embodiments of the present invention. The server 900 may be representative, for example, of the server 302 (FIG. 3). In some embodiments, the server 900 may include or operate a context oriented application 104, the context agent 102, and/or the presence and availability service 106, as well as text messaging service 108. The server 900 may be embodied as a single device or computer, a networked set or group of devices or computers, a workstation, mainframe or host computer, etc. In some embodiments, the server 900 may implement one more elements of the methods disclosed herein.

The server 900 may include a processor, microchip, central processing unit, or computer 902 that is in communication with or otherwise uses or includes one or more communication ports 904 for communicating with user devices and/or other devices. The communication ports 904 may include such things as local area network adapters, wireless communication devices, telephone network adapters, Bluetooth technology, etc. The server 900 also may include an internal clock element 906 to maintain an accurate time and date for the server 900, create time stamps for communications received or sent by the server 900, etc.

If desired, the server 900 may include one or more output devices 908 such as a printer, infrared or other transmitter, antenna, audio speaker, display screen or monitor, text to speech converter, etc., as well as one or more input devices 910 such as a bar code reader or other optical scanner, infrared or other receiver, antenna, magnetic stripe reader, image scanner, roller ball, touch pad, joystick, touch screen, microphone, computer keyboard, computer mouse, etc.

In addition to the above, the server 900 may include a memory or data storage device 920 to store information, software, databases, documents, communications, device drivers, etc. The memory or data storage device 920 may be implemented as an appropriate combination of magnetic, optical and/or semiconductor memory, and may include, for example, Read-Only Memory (ROM), Random Access Memory (RAM), a tape drive, flash memory, a floppy disk drive, a Zip™ disk drive, a compact disc and/or a hard disk. The server 900 also may include memory 914, such as ROM 916 and RAM 918.

The processor 902 and the data storage device 920 in the server 900 each may be, for example: (i) located entirely within a single computer or other computing device; or (ii) connected to each other by a remote communication medium, such as a serial port cable, telephone line or radio frequency transceiver. In one embodiment, the server 800 may be implemented as one or more computers that are connected to a remote server computer for maintaining databases.

A conventional personal computer or workstation with sufficient memory and processing capability may be used as the server 900. The server 900 may be capable of high volume transaction processing, performing a significant number of mathematical calculations in processing communications and database searches. A Pentium™ microprocessor such as the Pentium III™ or IV™ microprocessor, manufactured by Intel Corporation may be used for the processor 902. Other suitable processors may be available from Motorola, Inc., AMD, or Sun Microsystems, Inc. The processor 902 also may be embodied as one or more microprocessors, computers, computer systems, etc.

Software may be resident and operating or operational on the server 900. The software may be stored on the data storage device 920 and may include a control program 922 for operating the server, databases, etc. The control program 922 may include or interface to the context agent 102, context-oriented applications 104, presence and availability service 106, and messaging service 108.

The control program 922 may control the processor 902. The processor 902 may perform instructions of the control program 920, and thereby operate in accordance with the methods described in detail herein. The control program 922 may be stored in a compressed, uncompiled and/or encrypted format. The control program 922 furthermore includes program elements that may be necessary, such as an operating system, a database management system and device drivers for allowing the processor 902 to interface with peripheral devices, databases, etc. Appropriate program elements are known to those skilled in the art, and need not be described in detail herein.

The server 900 also may include or store information regarding identities, user devices, contexts, presence information, communications, outgoing default messages, etc., in database(s) 924. For example, information regarding one or more identities may be stored in an identity information database for use by the server 900 or another device or entity. Information regarding one or more identity or device contexts may be stored in a context information database for use by the server 900 or another device or entity; information regarding presence rules may be stored in a presence information database for use by the server 900 or another device or entity. Information regarding other application program data may be stored in application database (not shown). In some embodiments, some or all of one or more of the databases may be stored or mirrored remotely from the server 900.

According to some embodiments, the instructions of the control program may be read into a main memory from another computer-readable medium, such as from the ROM 916 to the RAM 918. Execution of sequences of the instructions in the control program causes the processor 902 to perform the process elements described herein. In alternative embodiments, hard-wired circuitry may be used in place of, or in combination with, software instructions for implementation of some or all of the methods described herein. Thus, embodiments are not limited to any specific combination of hardware and software.

The processor 902, communication ports 904, clock 906, output device 908, input device 910, data storage device 912, ROM 916, and RAM 918 may communicate or be connected directly or indirectly in a variety of ways. For example, the processor 902, communication ports 902, clock 906, output device 908, input device 910, data storage device 912, ROM 916, and RAM 918 may be connected via a bus 934.

While specific implementations and hardware/software configurations for the server 900 have been illustrated, it should be noted that other implementations and hardware configurations are possible and that no specific implementation or hardware/software configuration is needed. Thus, not all of the components illustrated in FIG. 9 may be needed for the server 900 implementing the methods disclosed herein.

The methods described herein may be embodied as a computer program developed using an object oriented language that allows the modeling of complex systems with modular objects to create abstractions that are representative of real world, physical objects and their interrelationships. However, it would be understood by one of ordinary skill in the art that the invention as described herein could be implemented in many different ways using a wide range of programming techniques as well as general-purpose hardware systems or dedicated controllers. In addition, in some embodiments, many, if not all, of the elements for the methods described above are optional or can be combined or performed in one or more alternative orders or sequences and the claims should not be construed as being limited to any particular order or sequence, unless specifically indicated.

Each of the methods described above can be performed on a single computer, computer system, microprocessor, etc. In addition, in some embodiments, two or more of the elements in each of the methods described above could be performed on two or more different computers, computer systems, microprocessors, etc., some or all of which may be locally or remotely configured. The methods can be implemented in any sort or implementation of computer software, program, sets of instructions, programming means, code, ASIC, or specially designed chips, logic gates, or other hardware structured to directly effect or implement such software, programs, sets of instructions, programming means or code. The computer software, program, sets of instructions or code can be storable, writeable, or savable on any computer usable or readable media or other program storage device or media such as a floppy or other magnetic or optical disk, magnetic or optical tape, CD-ROM, DVD, punch cards, paper tape, hard disk drive, Zip™ disk, flash or optical memory card, microprocessor, solid state memory device, RAM, EPROM, or ROM.

The foregoing description of the invention has been presented for purposes of illustration and description. It is not intended to be exhaustive or to limit the invention to the precise form disclosed, and modifications and variations are possible in light of the above teachings or may be acquired from practice of the invention. The drawings and description were chosen in order to explain the principles of the invention and its practical application. The drawings are not necessarily to scale and illustrate the device in schematic block format. It is intended that the scope of the invention be defined by the claims appended hereto, and their equivalents

What is claimed is:

1. A telecommunications device, comprising:
a telephony controller;
a presence controller configured to provide an indicia of an identity context associated with a user of the telecommunications device;
a ringer controller configured to control an output of a ringer, said ringer adapted to provide an output when an incoming call is detected by said telephony controller;
wherein said ringer controller is configured to select a particular output responsive to said indicia.

2. A telecommunications device in accordance with claim 1, said identity context indicative of a presence state of a device user.

3. A telecommunications device in accordance with claim 1, wherein said ringer output comprises one or more physical vibrations.

4. A telecommunications device in accordance with claim 1, wherein said ringer output comprises one or more audible tones.

5. A telecommunications device in accordance with claim 1, wherein said telephony controller comprises a cellular telephony controller.

6. A telecommunications device in accordance with claim 1, wherein said presence controller maintains a presence application for determining user presence.

7. A telecommunications device in accordance with claim 6, wherein said presence controller receives presence indicia from a presence server.

8. A method, comprising:
receiving a user presence indication at a cellular telephone;
accessing a ring configuration of said cellular telephone responsive to said receiving; and
changing said ring configuration based on said user presence indication.

9. A method in accordance with claim 8, wherein said ring configuration comprises a vibration configuration.

10. A method in accordance with claim 8, wherein said ring configuration comprises a ring tone configuration.

11. A method in accordance with claim 8, wherein said receiving comprises receiving said user presence indication via a text message.

12. A method in accordance with claim 8, wherein said receiving comprises receiving said user presence indication via a presence portal.

13. A telecommunications system comprising:
a presence service;
a wireless telephone service;
a plurality of user devices having notification controls configured to provide a notification indicia to a user indicative of an incoming call using said wireless telephone service;
wherein said notification controls are configured to change a notification indicia based on an input from said presence service.

14. A telecommunications system in accordance with claim 13, said notification indicia comprising one or more audible tones.

15. A telecommunications system in accordance with claim 13, said notification indicia comprising a vibrational mode.

16. A telecommunications system in accordance with claim 13, said input from said presence service comprising a presence text message.

17. A telecommunications system in accordance with claim 13, said input from said presence service comprising a presence portal message.

18. A telecommunications system in accordance with claim 13, wherein said notification controls are adapted to access and change one or more configuration files of a user device.

19. A method in accordance with claim 8, wherein said receiving comprises receiving said user presence indication via SIP Signaling.

20. A telecommunications system in accordance with claim 13, said input from said presence service comprising presence SIP signaling.
